(19) United States
(12) Patent Application Publication
(10) Pub. No.: US 2008/0115682 A1
(43) Pub. Date: May 22, 2008

(54) CLEANING DEVICE AND PRINTER

(75) Inventors: Fumito Kajitani, Hiroshima-Ken (JP); Shigeo Makino, Hiroshima-Ken (JP); Yukikazu Shoji, Hiroshima-Ken (JP); Yoshiaki Kanda, Hiroshima-Ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 11/942,558

(22) Filed: Nov. 19, 2007

(30) Foreign Application Priority Data
Nov. 20, 2006 (JP) 2006-313415

(51) Int. Cl. B41F 35/04

(52) U.S. Cl. 101/425

(57) ABSTRACT

A cleaning device that cleans an ink-supply path of a printer including a plurality of cylinders that constitute the ink-supply path. The cleaning device supplies cleaning solution from a cleaning nozzle to an ink-transfer cylinder in the state where the ink-transfer cylinder is not in contact with an ink-source cylinder, and a blanket cylinder is not in contact with a recording medium. After the cleaning solution is supplied to all the cylinders, a cleaning-solution collecting cylinder is brought into contact with an inking cylinder to collect waste cleaning solution therefrom. A cleaning-solution removing blade removes the waste cleaning solution from the cleaning-solution collecting cylinder.

### BACKGROUND OF THE INVENTION

1. Field of the Invention

The present invention generally relates to a technology for cleaning a printer. The present invention specifically relates to a technology for cleaning an ink-supply path of a printer.

2. Description of the Related Art

A printer has an ink-supply path for supplying an ink to a recording medium. The ink-supply path needs to be cleaned regularly to maintain high printing quality. Besides, upon switching between colors for use, if a color used before is left, the printing quality degrades. This also necessitate the cleaning of the ink-supply path. Japanese Patent Application Laid-open No. H2-153743 (pp. 3 to 6, and FIG. 1) discloses a conventional technology for cleaning an ink-supply path, in which at least an ink-supply source adjacent to a printing cylinder is separated from the printing cylinder, and cleaning solution is supplied to a predetermined region in the ink-supply path to clean the ink-supply path. Rollers for supplying ink and for supplying dampening water adjacent to the printing cylinder are brought into contact with the printing cylinder to supply cleaning solution from the ink-supply path to a dampening-water supply path via a press plate on the printing cylinder.

According to the conventional technology, however, at least a blanket cylinder, which is closer to an ink-supply source than the printing cylinder is, needs to be cleaned separately from the ink-supply path. Therefore, the cleaning cannot be performed effectively.

### SUMMARY OF THE INVENTION

It is an object of the present invention to at least partially solve the problems in the conventional technology.

According to an aspect of the present invention, a cleaning device that cleans an ink-supply path of a printer through which ink from an ink-supply source flows, the printer including a plurality of cylinders that constitutes the ink-supply path, includes a supply member that supplies cleaning solution for cleaning the ink-supply path from a predetermined position of the ink-supply path in a state where all the cylinders are in contact with each other; and a removing member that is located at a predetermined position in the ink-supply path, and, after the cleaning solution is supplied throughout the ink-supply path, that removes the cleaning solution from the ink-supply path in a state where all the cylinders are in contact with each other.

According to another aspect of the present invention, a printer includes plurality of cylinders that constitutes an ink-supply path, and a cleaning device that cleans the ink-supply path. The cleaning device includes a supply member that supplies cleaning solution for cleaning the ink-supply path from a predetermined position of the ink-supply path in a state where all the cylinders are in contact with each other; and a removing member that is located at a predetermined position in the ink-supply path, and, after the cleaning solution is supplied throughout the ink-supply path, that removes the cleaning solution from the ink-supply path in a state where all the cylinders are in contact with each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a printing system including a printer according to an embodiment of the present invention;

FIG. 2 is a schematic diagram of the printer including a cleaning device according to the embodiment;

FIG. 3 is a schematic diagram of a cleaning device according to a first modification of the embodiment;

FIG. 4 is a schematic diagram of a cleaning device according to a second modification of the embodiment; and

FIG. 5 is a flowchart of an example of for the process of cleaning the printer by the cleaning device.

### DETAILED DESCRIPTION OF THE PREFERRED EMBODIMENTS

Exemplary embodiments of the present invention are explained in detail below with reference to the accompanying drawings. The present invention is suitably applied to a printer using an aqueous ink that allows the use of an aqueous cleaning solution having small influence (e.g., decreasing durability) to a printing plate or a printing blanket. However, the present invention can also be applied to a printer using other types of ink such as a solvent ink so long as it allows the use of cleaning solution having small influence to a printing plate or a printing blanket.

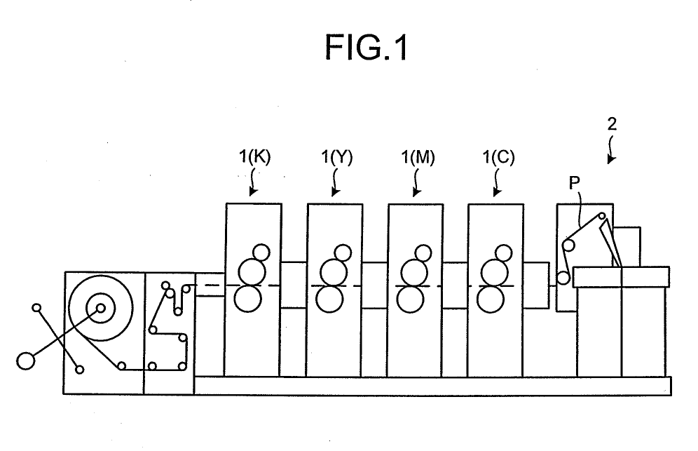

FIG. 1 is a schematic diagram of a printing system 2 including a printer 1 (printers 1(Y), 1(M), 1(C), and 1(K)) according to an embodiment of the present invention. The printer 1 is explained as an offset printer in which an image formed by applying ink to an image area on a plate is transferred onto a recording medium via a blanket.

As shown in FIG. 1, the printing system 2 includes the printers 1(Y), 1(M), 1(C), and 1(K) for four colors of yellow (Y), magenta (M), cyan (C), and black (K) generally used in printing. The printer 1 prints an image on a surface of a recording medium (hereinafter, “sheet”) P. The printer 1 includes a printing unit to print an image on one side of the sheet P. The printer 1 can include a plurality of printing units to print an image on both sides of the sheet P for duplex printing.

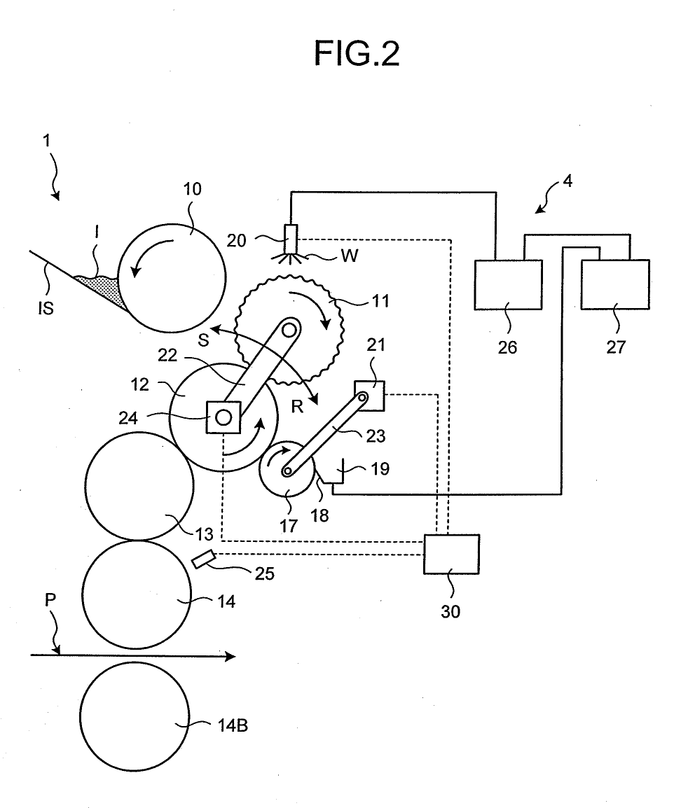

FIG. 2 is a schematic diagram of the printer 1 including a cleaning device 4. The printer 1 includes an ink storage IS, an ink-source cylinder 10, an ink-transfer cylinder 11, an inking cylinder 12, a plate cylinder 13, and a blanket cylinder 14. The inking cylinder 12 is made of rubber (e.g., nitrile rubber: NBR). A rubber blanket is fitted to the blanket cylinder 14. The configuration of the printer 1 is not limited to the one shown in FIG. 2, and the printer 1 can include other cylinders as required.

The plurality of cylinders constitutes an ink-supply path, through which ink from an ink-supply source travels until it is transferred onto a recording medium. Specifically, the ink-source cylinder 10, the ink-transfer cylinder 11, the inking cylinder 12, the plate cylinder 13 and the blanket cylinder 14 constitute the ink-supply path, through which ink passes from the ink-transfer cylinder 11 to the sheet P. Cleaning solution is supplied for cleaning the ink-supply path from a predetermined position thereof in the state where all the cylinders are in contact with each other. The cleaning solution is removed from the ink-supply path after the cleaning solution is supplied to the entire ink-supply path in the state where all the cylinders are in contact with each other.

When ink is supplied from the ink storage IS by using the ink-source cylinder 10, the ink-supply source is the ink storage IS and the ink-source cylinder 10. When ink is directly supplied from an ink head, the ink-supply source is the ink head.

FIG. 2 depicts the cleaning device 4 that is cleaning the printer 1. At the time of cleaning, the ink-source cylinder 10 and the ink-transfer cylinder 11 are away from each other, and the blanket cylinder 14 and the sheet P are away from each other. At the time of printing, the ink-source cylinder 10 and the ink-transfer cylinder 11 come in contact with each other, and the sheet P is pressed to the blanket cylinder 14 by a backup cylinder 14B.

Ink I is supplied from the ink storage IS to the ink-source cylinder 10, and then is supplied to the ink-transfer cylinder 11 that comes in contact with the ink-source cylinder 10. A metal anilox cylinder is used as the ink-transfer cylinder 11. Apart from an anilox cylinder, examples of the ink-transfer cylinder 11 include, but are not limited to, a rubber cylinder, and a cylinder having pores on the surface thereof. The ink I can be supplied to the ink-transfer cylinder 11 by spraying it onto the ink-transfer cylinder 11 with a spray or the like.

The ink-transfer cylinder 11 comes in contact with the inking cylinder 12, and the ink I (aqueous ink in the embodiment) on the surface of the ink-transfer cylinder 11 is transferred onto the inking cylinder 12. The inking cylinder 12 comes in contact with the plate cylinder 13, and the ink I on the surface of the inking cylinder 12 is transferred onto an image area on a plate (flat plate) fitted to the plate cylinder 13. On the plate, the ink I forms an image to be printed on the sheet P. The image is transferred onto the blanket fitted to the blanket cylinder 14, and is then transferred onto the sheet P.

As described above, at the time of cleaning the printer 1, the ink-source cylinder 10 and the ink-transfer cylinder 11 are not in contact with each other, and the blanket cylinder 14 and the sheet P are not in contact with each other. This mechanism is explained. The ink-transfer cylinder 11 is swingably supported by a movable arm 22 about a rotation axis of the inking cylinder 12. The movable arm 22 is driven by an arm actuator 24. The movable arm 22 and the arm actuator 24 form a separating mechanism that separates the ink-supply source (the ink storage IS and the ink-source cylinder 10) from the ink-supply path. The arm actuator 24 is controlled by a control unit 30.

At the time of printing, to bring the ink-source cylinder 10 into contact with the ink-transfer cylinder 11, the control unit 30 drives the arm actuator 24 to move the movable arm 22 in a direction in which the movable arm 22 approaches the ink-source cylinder 10 (direction indicated by arrow S in FIG. 2). Accordingly, the ink-transfer cylinder 11 supported by the movable arm 22 comes in contact with the ink-source cylinder 10, and the ink I is supplied from the ink-source cylinder 10 to the ink-transfer cylinder 11.

At the time of cleaning, to separate the ink-transfer cylinder 11 from the ink-source cylinder 10, the control unit 30 drives the arm actuator 24 so that the movable arm 22 is moved away from the ink-source cylinder 10 (in the direction of an arrow R in FIG. 2). Accordingly, the ink-transfer cylinder 11 supported by the movable arm 22 is away from the ink-source cylinder 10, and the ink-transfer cylinder 11 is separated from the ink-source cylinder 10. The cleaning solution is mixed in the ink-supply source, thereby avoiding a change of the property of the ink used for printing.

When the ink-supply source and the ink-supply path are cleaned, the ink-transfer cylinder 11 can be brought into contact with the ink-source cylinder 10, i.e., the ink-supply source and the ink-supply path can be connected and cleaned. With this, the ink-supply source and the ink-supply path can be cleaned collectively, and therefore, the cleaning time can be reduced as compared with the case that the ink-supply source and the ink-supply path are individually cleaned. In this case, if the cleaning solution is supplied from the ink storage IS as the ink-supply source, the ink storage IS can be efficiently cleaned.

At the time of printing, the backup cylinder 14B arranged to face the blanket cylinder 14 presses the sheet P against the blanket cylinder 14. Accordingly, an image transferred onto the blanket fitted to the blanket cylinder 14 is transferred onto the sheet P. At the time of cleaning, pressing by the backup cylinder 14B is released, so that the sheet P is separated from the blanket cylinder 14. The configuration of the cleaning device 4 is explained next.

The cleaning device 4 includes a cleaning nozzle 20, a cleaning-solution collecting cylinder 17, and a cleaning-solution removing blade 18. The cleaning nozzle 20 is used to supply a cleaning solution. The cleaning-solution collecting cylinder 17 removes the cleaning solution from the ink-supply path. The cleaning-solution removing blade 18 removes the cleaning solution from the cleaning-solution collecting cylinder 17. The cleaning device 4 further includes a waste cleaning-solution container 19, a cleaning-solution tank 26, and a cleaning-solution recycle member 27.

The waste cleaning-solution container 19 stores therein the cleaning solution after cleaning (hereinafter, “waste cleaning solution”) removed by the cleaning-solution removing blade 18. The cleaning-solution tank 26 stores therein the cleaning solution to be supplied to the cleaning nozzle 20. The cleaning-solution recycle member 27 collects and recycles the waste cleaning solution. The cleaning device 4 need not include the cleaning-solution recycle member 27, and, in this case, the waste cleaning solution is disposed of without being recycled.

At the time of cleaning the ink-supply path, the ink-source cylinder 10 is not in contact with the ink-transfer cylinder 11. In this state, cleaning solution W is supplied from the cleaning nozzle 20 to the ink-transfer cylinder 11. That is, the cleaning solution W is supplied from the uppermost stream side of the ink-supply path (closest to the ink-source cylinder 10). Accordingly, the cleaning solution W can be distributed throughout the ink-supply path by gravity, and reliably supplied to the entire ink-supply path. For example, a porous member (e.g., a sponge) soaked in the cleaning solution W can be used as a cleaning-solution supply member, and is brought into contact with the ink-transfer cylinder 11 or the like to supply the cleaning solution to the ink-supply path.

When the ink I is aqueous ink, aqueous cleaning solution (e.g., water or a liquid in which water is used as a solvent) is used. Because an aqueous cleaning solution can be used for cleaning in the case of using aqueous ink, the influence to the plate and the blanket is small. Accordingly, the cylinders (e.g., the ink-transfer cylinder 11 and the inking cylinder 12) not affected by the cleaning solution and the plate and the blanket need not be separated for cleaning, and the ink-supply path can be cleaned collectively.

When the cleaning solution is distributed throughout the ink-supply path, the cleaning-solution collecting cylinder 17 is brought into contact with the inking cylinder 12 with the cleaning-solution removing blade 18 being in contact with the cleaning-solution collecting cylinder 17. In the embodiment, the cleaning-solution removing blade 18 is always in contact with the cleaning-solution collecting cylinder 17.

When the cleaning-solution removing blade 18 is made of rubber or resin, it is desired that the cleaning-solution collecting cylinder 17 be made of a material having higher hardness than that of the cleaning-solution removing blade 18. For example, when a rubber blade is used for the cleaning-solution removing blade 18, metal is used for the cleaning-solution collecting cylinder 17. The cleaning-solution removing blade 18 can be made of metal. In this case, the hardness of the cleaning-solution collecting cylinder 17 need not be higher than that of the cleaning-solution removing blade 18.

The cleaning-solution collecting cylinder 17 is supported by a cylinder actuator 21 via a support arm 23. When the cleaning solution is removed from the ink-supply path, the cylinder actuator 21 brings the cleaning-solution collecting cylinder 17 into contact with the inking cylinder 12. Accordingly, the cleaning solution used to clean the ink-supply path moves from the inking cylinder 12 to the cleaning-solution collecting cylinder 17, and is removed from the cleaning-solution collecting cylinder 17 by the cleaning-solution removing blade 18. That is, the cleaning solution is removed from the ink-supply path by the cleaning-solution removing blade 18 via the cleaning-solution collecting cylinder 17, and collected in the waste cleaning-solution container 19.

In the embodiment, the waste cleaning solution is removed from the inking cylinder 12 made of rubber and is collected via the cleaning-solution collecting cylinder 17. Accordingly, the waste cleaning solution can be reliably collected from a cylinder having a non-smooth surface or a soft surface. If there is a metal cylinder having a smooth surface in the ink-supply path, the cleaning-solution removing blade 18 can be brought into contact with the metal cylinder to directly remove the waste cleaning solution from the ink-supply path.

In the cleaning device 4, the waste cleaning solution is removed from the inking cylinder 12 arranged around the middle of the ink-supply path via the cleaning-solution collecting cylinder 17. Accordingly, the waste cleaning solution can be collected at substantially the same distance from the cylinders (the blanket cylinder 14 and the ink-transfer cylinder 11 in the embodiment) on the opposite ends of the ink-supply path. As a result, the time for collecting the cleaning solution can be reduced as compared with the case that the waste cleaning solution is collected from a cylinder on an end of the ink-supply path.

When the ink-supply path has been cleaned, supply of the cleaning solution is suspended, and the removal of the cleaning solution by the cleaning-solution collecting cylinder 17 and the cleaning-solution removing blade 18 is continued until the cleaning solution on the ink-supply path is removed. In the cleaning device 4, when the density of ink on the surface of the blanket cylinder 14 becomes smaller than a predetermined value, it is determined that the ink-supply path has been cleaned. A densitometer 25 is provided at a position close to the surface of the blanket cylinder 14 to measure the density of ink on the surface of the blanket cylinder 14. After the cleaning solution has been removed from the ink-supply path, the control unit 30 drives the cylinder actuator 21 to separate the cleaning-solution collecting cylinder 17 from the inking cylinder 12.

The waste cleaning solution collected in the waste cleaning-solution container 19 is delivered to the cleaning-solution recycle member 27. The cleaning-solution recycle member 27 removes impurities such as pigment components of ink and dust from the waste cleaning solution. Examples of the cleaning-solution recycle member 27 include, but are not limited to, a centrifugal separator and a filter. The cleaning solution, from which the pigment components, dust, etc. have been removed, is returned to the cleaning-solution tank 26 and reused. Thus, with the cleaning-solution recycle member 27, waste can be reduced by effectively using the cleaning solution. Accordingly, the environmental load can be reduced.

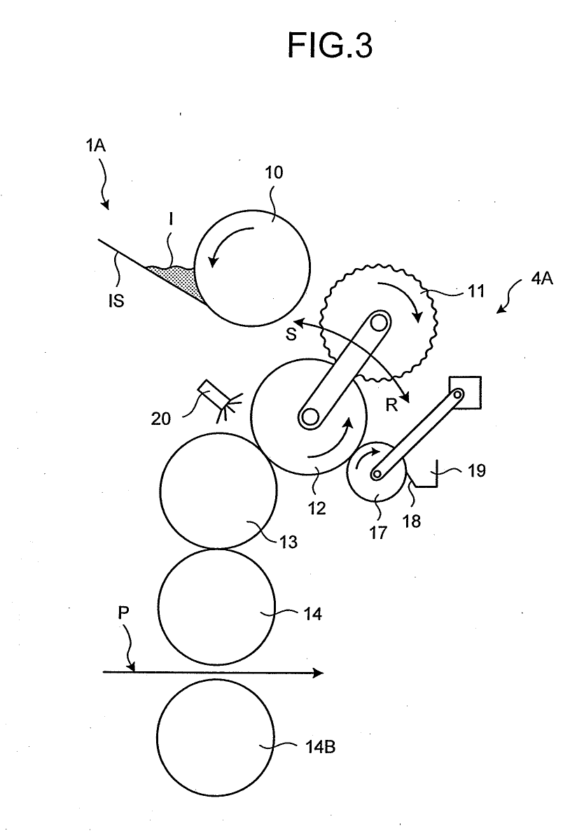

FIG. 3 is a schematic diagram of a cleaning device 4A according to a first modification of the embodiment. The cleaning device 4A is of basically the same configuration as the cleaning device 4 except that the cleaning solution is supplied from between the cylinders. Therefore, the same explanation is not repeated. In FIG. 3, the control unit 30, the cleaning-solution tank 26, and the cleaning-solution recycle member 27 are omitted.

In the cleaning device 4A, the cleaning solution W is supplied from the cleaning nozzle 20 to between the inking cylinder 12 and the plate cylinder 13. The cleaning solution W can be supplied to between the plate cylinder 13 and the blanket cylinder 14 or between the ink-transfer cylinder 11 and the inking cylinder 12.

When the cleaning solution W is sprayed from the cleaning nozzle 20 to supply it to between the cylinders in the ink-supply path, scattering of the cleaning solution W can be suppressed. Accordingly, the cleaning solution W can be effectively used, resulting in less consumption of the cleaning solution W. In addition, dirt in the printer 1 due to scattering of the cleaning solution W can be reduced. Because the cleaning solution W supplied to between the cylinders is spread while passing through between the cylinders, the cleaning solution W can be efficiently distributed in an axial direction (width direction) of the cylinders. Thus, the cleaning time and the consumption of the cleaning solution W can be reduced.

As described above, according to the first modification, the cleaning solution is supplied from between the inking cylinder 12 and the plate cylinder 13, i.e., a position around the middle of the ink-supply path. Thus, the cleaning solution can be distributed throughout the ink-supply path in a shorter period of time as compared with the case that the cleaning solution is supplied from a position at an end of the ink-supply path (the ink-transfer cylinder 11 or the blanket cylinder 14). Thus, the cleaning time can be reduced.

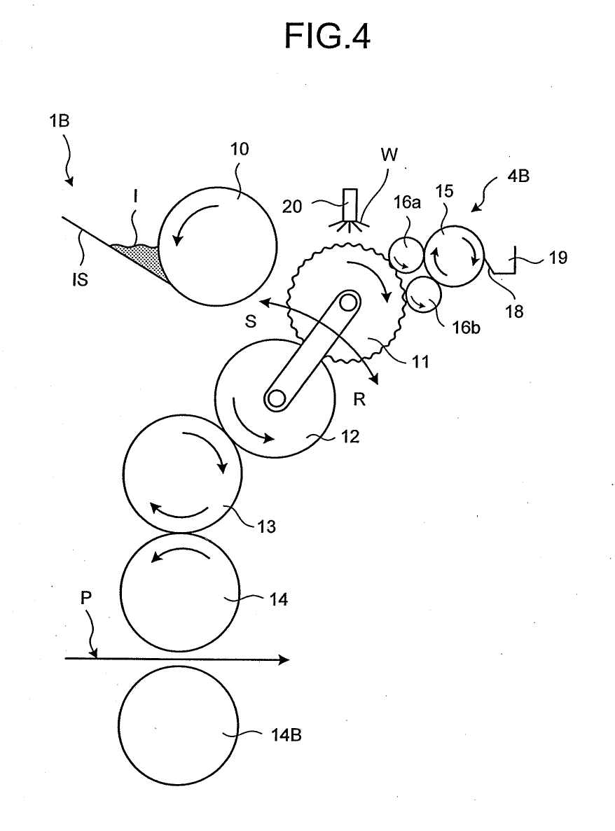

FIG. 4 is a schematic diagram of a cleaning device 4B according to a second modification of the embodiment. The cleaning device 4B is of basically the same configuration as the cleaning device 4 except that the cleaning solution is scraped by the cleaning-solution removing blade 18 from the ink-transfer cylinder 11, to which the cleaning solution has been supplied, via a rubber cylinder and a metal cylinder. Therefore, the same explanation is not repeated. In FIG. 4, the control unit 30, the cleaning-solution tank 26, and the cleaning-solution recycle member 27 are omitted.

As shown in FIG. 4, as the ink-transfer cylinder 11 is used a metal anilox cylinder having a non-smooth surface, from which the cleaning solution cannot be directly removed by the cleaning-solution removing blade 18. Accordingly, in the cleaning device 4B, the cleaning solution is removed from the ink-transfer cylinder 11 by first cleaning-solution-collecting cylinders 16a and 16b and a second cleaning-solution-collecting cylinder 15 for removing the cleaning solution from the ink-supply path. The cleaning solution is then removed from the second cleaning-solution-collecting cylinder 15 by the cleaning-solution removing blade 18.

Because the first cleaning-solution-collecting cylinders 16a and 16b are brought into contact with the surface of the ink-transfer cylinder 11 formed of an anilox cylinder, the first cleaning-solution-collecting cylinders 16a and 16b are made of a soft elastic material such as rubber or elastomer. The cleaning-solution removing blade 18 is brought into contact with the second cleaning-solution-collecting cylinder 15 to remove the cleaning solution on the surface thereof. Therefore, when the cleaning-solution removing blade 18 is made of rubber or resin, the second cleaning-solution-collecting cylinder 15 is made of a material (e.g., metal) having higher hardness than that of the cleaning-solution removing blade 18. In the second modification, the two first cleaning-solution-collecting cylinders 16a and 16b are used; however, the number of them is not limited to two.

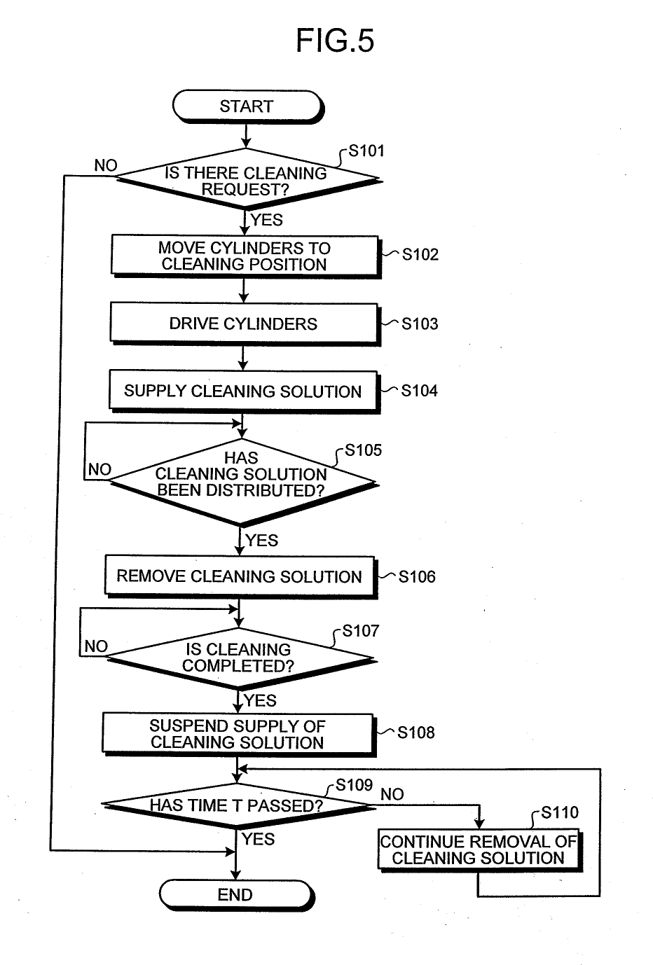

FIG. 5 is a flowchart of an example of the process of cleaning the printer 1 performed by the cleaning device 4 (4A, 4B). First, the control unit 30 determines whether there is a cleaning request (step S101). Because cleaning is performed between printing jobs, the control unit 30 determines that there is no cleaning request, for example, during printing. When there is no cleaning request (NO at step S101), the process ends.

When there is a cleaning request (YES at step S101), the control unit 30 drives the arm actuator 24, so that the ink-transfer cylinder 11 is separated from the ink-source cylinder 10 (step S102). The control unit 30 also moves the backup cylinder 14B in a direction away from the blanket cylinder 14 (step S102), so that the blanket cylinder 14 is separated from the sheet P.

The control unit 30 drives the cylinders constituting the ink-supply path (step S103), and supplies cleaning solution from the cleaning nozzle 20 to the ink-supply path (step S104). Incidentally, the process at step S104 can be performed before the process at step S103, and the cylinders can be driven after supply of the cleaning solution starts. When supply of the cleaning solution starts, the control unit 30 determines whether the cleaning solution is distributed throughout the ink-supply path (step S105). For example, when the cleaning solution reaches the cylinder at a position farthest from the cleaning nozzle 20, the control unit 30 can determine that the cleaning solution has been distributed throughout the ink-supply path. Alternatively, by previously calculating the time taken from the start of supply of the cleaning solution until the cleaning solution is distributed throughout the ink-supply path, the control unit 30 can determine that the cleaning solution has been distributed throughout the ink-supply path when the time has passed since the start of supply of the cleaning solution.

When the cleaning solution has not yet been distributed throughout the ink-supply path (NO at step S105), the control unit 30 waits until the cleaning solution is distributed throughout the ink-supply path. When the cleaning solution has been distributed throughout the ink-supply path (YES at step S105), the control unit 30 starts removing waste cleaning solution (step S106). The removal of the waste cleaning solution can be started after a predetermined time has passed since the cleaning solution was distributed throughout the ink-supply path taking into consideration the time which it takes for the cleaning solution to remove dirt on the surface of each cylinder.

At the time of removing the waste cleaning solution, the control unit 30 drives the cylinder actuator 21 to press the cleaning-solution collecting cylinder 17 against the inking cylinder 12. Accordingly, the waste cleaning solution on the inking cylinder 12 moves to the cleaning-solution collecting cylinder 17. Because the cleaning-solution removing blade 18 is always in contact with the cleaning-solution collecting cylinder 17, the cleaning solution on the cleaning-solution collecting cylinder 17 can be removed by the cleaning-solution removing blade 18. Supply of the cleaning solution is continued even after the cleaning-solution removing blade 18 starts removing the waste cleaning solution. Consequently, the waste cleaning solution that has been used to remove the dirt on the ink-supply path is removed, and a new cleaning solution including no dirt is supplied instead. Thus, cleaning of the ink-supply path proceeds.

The control unit 30 then determines whether cleaning is completed (step S107). Specifically, the control unit 30 measures the density of ink on the surface of the blanket fitted to the blanket cylinder 14 with the densitometer 25. When the measured density is lower than a preset threshold density, the control unit 30 determines that cleaning of the ink-supply path is completed. When cleaning is not completed (NO at step S107), the control unit 30 continues the removal of the waste cleaning solution by the cleaning-solution removing blade 18 while supplying the cleaning solution.

When cleaning is completed (YES at step S107), the control unit 30 suspends supply of the cleaning solution (step S108). The control unit 30 then determines whether a predetermined time T has passed (step S109). The predetermined time T is a time period required from suspension of supply of the cleaning solution until the cleaning solution is removed from the ink-supply path. The cleaning-solution collecting cylinder 17 and the cleaning-solution removing blade 18 continues the removal of the waste cleaning solution under the control of the control unit 30 even after supply of the cleaning solution is suspended.

If the predetermined time T has not yet passed (NO at step S109), the cleaning-solution collecting cylinder 17 and the cleaning-solution removing blade 18 continues the removal of the cleaning solution (step S110). When the predetermined time T has passed (YES at step S109), the control unit 30 determines that cleaning of the ink-supply path is completed, and finishes cleaning. Thereafter, the control unit 30 drives the cylinder actuator 21 to move the cleaning-solution collecting cylinder 17 away from the inking cylinder 12, and prepares for the next printing.

According to the embodiment and the modifications thereof, the plurality of cylinders constitutes the ink-supply path. Cleaning solution is supplied for cleaning the ink-supply path in the state where all the cylinders are in contact with each other. The cleaning solution is removed from the ink-supply path after the cleaning solution is supplied to the entire ink-supply path in the state where all the cylinders are in contact with each other. Thus, the cylinders can be cleaned collectively, and cleaning for each cylinder is not required, which reduces the time taken to clean the ink-supply path. Because constituent elements of the printer such as the cylinders can be cleaned without being detached, cleaning can easily be automated.

As set forth hereinabove, according to an embodiment of the present invention, a printing plate and a printing blanket can be prevented from being damaged in the process of removing a cleaning-solution.

Moreover, the cleaning solution can be prevented from mixing into ink to be used for printing in an ink-supply source and changing the properties of the ink.

Furthermore, cylinders that constitute an ink-supply path of a printer can be cleaned collectively, and cleaning for each cylinder is not necessary. As a result, the time required for cleaning the ink-supply path can be reduced. Thus, an actual printing time increases, which improves productivity.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A cleaning device that cleans an ink-supply path of a printer through which ink from an ink-supply source flows, the printer including a plurality of cylinders that constitutes the ink-supply path, the cleaning device comprising:
a supply member that supplies cleaning solution for cleaning the ink-supply path from a predetermined position of the ink-supply path in a state where all the cylinders are in contact with each other; and
a removing member that is located at a predetermined position in the ink-supply path, and, after the cleaning solution is supplied throughout the ink-supply path, that removes the cleaning solution from the ink-supply path in a state where all the cylinders are in contact with each other.

2. The cleaning device according to claim 1, wherein
the cylinders include a plate cylinder, and
the removing member is closer to the ink-supply source than the plate cylinder is.

3. The cleaning device according to claim 1, further comprising a moving member that comes in contact with any one of the cylinders such that the cleaning solution after cleaning moves from the cylinder onto the moving member, wherein
the removing member removes the cleaning solution after cleaning from the moving member.

4. The cleaning device according to claim 1, further comprising a separating mechanism that separates the ink-supply source from the ink-supply path upon cleaning.

5. The cleaning device according to claim 1, wherein the cleaning solution is supplied to a portion where a pair of the cylinders are in contact with each other.

6. The cleaning device according to claim 1, further comprising a recycling member that removes impurities from the cleaning solution after cleaning removed by the removing member.

7. A printer comprising:
a plurality of cylinders that constitutes an ink-supply path; and
a cleaning device that cleans the ink-supply path, and includes
a supply member that supplies cleaning solution for cleaning the ink-supply path from a predetermined position of the ink-supply path in a state where all the cylinders are in contact with each other; and
a removing member that is located at a predetermined position in the ink-supply path, and, after the cleaning solution is supplied throughout the ink-supply path, that removes the cleaning solution from the ink-supply path in a state where all the cylinders are in contact with each other.
